(19) United States
(12) Patent Application Publication
(10) Pub. No.: US 2011/0035435 A1
(43) Pub. Date: Feb. 10, 2011

(54) METHOD AND SYSTEM FOR CONVERTING DESKTOP APPLICATION TO WEB APPLICATION

(75) Inventors: Xin MENG, Beijing (CN); Jingwei SHI, Beijing (CN); Cailiang SONG, Beijing (CN); Lian WANG, Beijing (CN); Huifeng LIU, Beijing (CN); Xiaowei LIU, Beijing (CN)

Correspondence Address: SUGHRUE MION, PLLC, 2100 PENNSYLVANIA AVENUE, N.W., SUITE 800, WASHINGTON, DC, 20037, US

(73) Assignee: NEC (CHINA) CO., LTD., Beijing (CN)

(21) Appl. No.: 12/818,438

(22) Filed: Jun. 18, 2010

(30) Foreign Application Priority Data
Aug. 10, 2009 (CN) 200910159265.5

(51) Int. Cl. G06F 15/16

(52) U.S. Cl. 709/203

(57) ABSTRACT

The present invention provides methods and systems for converting a desktop application to a Web application. The method comprises: inputting, at a client side, URL of a desired desktop application and sending it to a server; the server providing a code conversion tool (e.g. JavaScript code) to the client and loading the desktop application; at the server, extracting interface information of the loaded desktop application, wrapping the interface information to data in an interface descriptive language format (e.g. XML data), and sending the wrapped data back to the client; and at the client, parsing the XML data by utilizing the code conversion tool to generate relevant webpage elements (e.g. HTML data), so as to display the desktop application. In another embodiment, the server can directly run the code conversion tool to implement the code conversion from XML data to HTML webpage elements.

### FIELD OF THE INVENTION

This invention generally relates to computer networking technology, and more specifically, to method and system for converting a desktop application to a Web application.

### BACKGROUND

With development of cloud computing and the Internet, there are increasing needs of the users to enjoy various services anytime and anywhere. However, many of the existing desktop applications (standalone or client-server versions) require the user to install a client before conducting corresponding operations, and thus the services cannot be provided anytime and anywhere. If the existing system is abandoned to re-develop a brand new browser-server version of the system with the set of exactly same functions from the ground up, the development cost would be very high and it is a waste of the original system. Thus, there is a strong need to provide an efficient system conversion solution.

More importantly, mashup is an important portion in cloud computing, which enables people to use integrated multiple services in a more convenient way. Therefore, the Web application generated by conversion should achieve not only all the functions of the original system, it should also be capable of being secondly utilized (i.e. changing the layout style, or aggregating with other network resources). In this way, it is able to achieve highly efficient usage of the original application.

The existing application conversion systems include mainly two possibilities. One is that the source code of the desktop application is available. In this case, if the source code is written by using simple programming language (e.g. PowerBuilder), it may be possible for developers to create new Web application semi-automatically. Otherwise, they have to develop manually after reading the source code and analyzing all the code logic. That is, the developers have to understand all the functions of the original application and be very proficient at network programming. Even so, however, it is too time-consuming and costly for developers to achieve conversion of all the functions. The other is in the case that the source code is unavailable. For system developers, the source codes of the majority of the existing applications are unavabilable. Therefore, There is only one way to implement automatic conversion. That is to repaint the graphic user interface (GUI) of the desktop application on the webpage and make the original system responsible for responding the operations the user does on the webpage, which is somewhat like remote desktop technology. The technology provided by the present invention is mainly related to the latter case.

In the case that there is no source code available, the US patent application U.S. Pat. No. 6,950,991B2, entitled “Interacting with Software Applications Displayed in a Web Page” and filed on Feb. 6, 2002, provides an application conversion method. This method displays the picture of the GUI of the existing desktop application in a way of remote desktop on a certain location on the client webpage. FIGS. 8 and 9 show respectively the structural block diagram and operation flow chart of the prior art system.

As shown in FIG. 8, in the system, the client 80 includes, in addition to a browser, a client agent 810, which is installed in a form of plug-in in the client 80. The client agent 810 includes a monitor unit 801, a command unit 802, a message transmitting unit 803 and a message receiving unit 804. The client agent 810 may monitor and respond to events associated with one or more application-output windows located in the Web browser window, such as, detect an event of user input to the browser for adjusting the size of the window, and in response, adjust the size of the related application-output window. The client agent 810 is for example conducted/instantialized responsive of the application object 820 and performs various functions independent to the browser. The application object 820 is for example an ActiveX control embedded in a webpage displayed in the Web browser window, and includes properties (e.g. the location, height, width, border style, etc) of the application-output window, the name of the application program and the address of the application execution server. The monitor unit 801 monitors (1) the client desktop in order to detect changes (events: e.g. keystrokes, mouse clicking, resize event, etc. in the on or off-screen surface) affecting the application-output window (2). The command unit 802 controls the monitor unit 801, the message transmitting unit 803 and the message receiving unit 804 through instructions, and transmits through the message transmitting unit 803 the event detected by the monitor unit 801 to the server 90 (3, 4). For example, the monitor unit 801 can report the command unit 802 of a click-on action occurred on the location of ordinates (354, 560) on the desktop. The command unit 802 can transmit this action (event) in a message to the server side via the message transmitting unit 803 (5). In addition, the command unit 802 is also responsible for modifying the property of the application object 820 (12) according to the received window attribute information, graphic data and command from the Server (10, 11). For example, the command unit 802 can direct the browser to display the application-output window on the specific location on the webpage according to the property of the application object.

On the server side, the server 90 includes a request receiving unit 901, an application running unit 902, a GUI print screen unit 904, a response transmitting unit 905 and (one or more) existing desktop applications 903. The request receiving unit 901 receives the event (5) transmitted from the message transmitting unit 803 of the client agent 810, and transmits the parsed request to the application running unit 902 (6). The application running unit 902 is responsible for starting or operating the corresponding application according to the received event (7). The GUI print screen unit 904 is in charge of obtaining the graphic data (i.e. GUI) of the application window from the server (8), and transmitting the data to the response transmitting unit 905 (9). The response transmitting unit 905 sends the response to the client agent 810 (10). This response may include graphic data of the application window, window property information and command.

FIG. 9 shows the working flow of the existing system shown in FIG. 8. The steps S1 and S2 are pre-processing steps, and thus were not explained above in terms of the structural block diagram FIG. 8. The other steps operate in the same manner as described above, and thus their detailed description is omitted.

The above-mentioned prior art solution transmits the GUI of the server-side desktop system in a manner of screen copy/snapshot to the browser side, and transmits the operating information (action/event) of the user on the browser webpage back to the server as relative ordinates information. In this manner, although the interactive interface of the original system can be repainted completely, the user is different to integrate such Web applications, because from a picture is the content information contained therein hard to be obtained. In addition, the existing system can hardly optimize or update the interface of the generated Web application.

### SUMMARY OF THE INVENTION

The present invention is made to provide a method and system for converting a desktop application to a Web application, which can obtain the content information of the desktop application conveniently, and optimize or update the interface (GUI) of the generated Web application.

The system conversion solution according to the present invention converts automatically the graphic interface information of the existing desktop application into data in an interface descriptive language format (e.g. Extensible Markup Language (XML) GUI data) for describing information of all the elements on the GUI, including identification, structure, content, layout information of the elements. Then, on the browser side, the received XML GUI data can be parsed and converted into webpage.

When the user operates a control on the webpage, its corresponding response function can be triggered. The response function sends action information (which control is triggered, what is the action, the corresponding parameters information, etc.) in request back to the desktop application on the server side, and on the desktop application, this action is redone. After the GUI of the desktop application is updated, likewise, the change is reported in a XML GUI format data to the browser for GUI update.

According to the first aspect of the invention, it is provided a method for converting a desktop application to a web application, comprising: inputting, at a client side, URL of a desired desktop application and sending it to a server; the server providing a code conversion tool (e.g. JavaScript code contained in the webpage) to the client and loading the desktop application; at the server, extracting interface information of the loaded desktop application, wrapping the interface information to data in an interface descriptive language format (e.g. XML GUI data), and sending the wrapped data back to the client; and at the client, parsing the received interface descriptive language data by utilizing the code conversion tool to generate relevant webpage elements (e.g. HTML code), so as to display the desktop application. Afterwards, when the user does an action on the displayed desktop application, the method further comprises the steps of: sending a request corresponding to the action to the server; at the server, redoing the action on the loaded desktop application and detecting change on the interface caused by the action, extracting interface change information corresponding to the interface change and wrapping the interface change information to data in the interface descriptive language format, and sending the wrapped data back to the client; and at the client, parsing the received interface descriptive language data by utilizing the code conversion tool to generate relevant webpage elements, and updating a corresponding part of the displayed desktop application according to the webpage elements.

According to the second aspect of the invention, it is provided a method for converting a desktop application to a web application, comprising: inputting, at a client side, URL of a desired desktop application and sending it to a server; the server loading the desktop application; at the server, extracting interface information of the loaded desktop application, and wrapping the interface information to data in an interface descriptive language format (e.g. XML GUI data); at the server, parsing the wrapped interface descriptive language data by utilizing an code conversion tool (e.g. JavaScript code contained in the webpage) to generate relevant webpage elements (e.g. HTML code) and sending the webpage elements back to the client; and at the client, displaying the desktop application according to the received webpage elements. Afterwards, when the user does an action on the displayed desktop application, the method further comprises the steps of: sending a request corresponding to the action to the server; at the server, redoing the action on the loaded desktop application and detecting interface change caused by the action, extracting interface information corresponding to the changed interface and wrapping the interface information to data in the interface descriptive language format; at the server, parsing the interface descriptive language data by utilizing the code conversion tool to generate relevant webpage elements and sending the webpage elements back to the client; and at the client, displayed the changed interface of the desktop application according to the received webpage elements.

According to the third aspect of the invention, it is provided a system for converting a desktop application to a web application, which comprises a client and a server. The client comprises: a request transmitting unit for transmitting URL of a desired desktop application; and a data receiving unit for receiving data from a server. The server comprises: a request receiving unit for receiving the URL; a tool providing unit for providing a code conversion tool (e.g. JavaScript code contained in the webpage) to the client; an application drive unit for loading the desktop application; an interface extraction unit for extracting interface information of the loaded desktop application and wrapping the interface information to data in an interface descriptive language format (e.g. XML GUI data); and a data transmitting unit for sending the interface descriptive language data wrapped by the interface extraction unit back to the client. At the client, the interface descriptive language data received by the data receiving unit is parsed by utilizing the code conversion tool to generate relevant webpage elements (e.g. HTML code), and the browser of the client displays the desktop application according to the generated webpage elements. When the user does an action on the desktop application displayed on the client, the request transmitting unit transmits a request (e.g. http request) corresponding to the action to the server. Then, at the server, the request receiving unit receives the request; the application drive unit redoes the action corresponding to the request on the interface of the desktop application; the interface extraction unit detects change on the interface caused by the action, extracts interface change information corresponding to the interface change and wraps the interface change information to data in the interface descriptive language format; and the data transmitting unit sends the wrapped interface descriptive language data back to the client. Then, at the client, the interface descriptive language data received by the data receiving unit is parsed by utilizing the code conversion tool to generate relevant webpage elements, and the browser of the client updates a corresponding part of the displayed desktop application according to the webpage elements.

According to the fourth aspect of the invention, it is provided a system for converting a desktop application to a web application, which comprises a client and a server. The client comprises: a request transmitting unit for transmitting URL of a desired desktop application; and a data receiving unit for receiving data from a server. The server comprises: a request receiving unit for receiving the URL; an application drive unit for loading the desktop application; an interface extraction unit for extracting interface information of the loaded desktop application and wrapping the interface information to data in an interface descriptive language format (e.g. XML GUI data); a code conversion unit for parsing the interface descriptive language data wrapped by the interface extraction unit to generate relevant webpage elements (e.g. HTML code); and a data transmitting unit for sending the webpage elements back to the client, wherein the browser of the client displays the desktop application according to the received webpage elements. When the user does an action on the desktop application displayed on the client, the request transmitting unit transmits a request (e.g. http request) corresponding to the action to the server. Then, at the server, the request receiving unit receives the request; the application drive unit redoes the action corresponding to the request on the interface of the desktop application; the interface extraction unit detects change on the interface caused by the action, extracts interface information corresponding to the changed interface and wraps the interface information to data in the interface descriptive language format; the code conversion unit parses the interface descriptive language data wrapped by the interface extraction unit to generate relevant webpage elements; and the data transmitting unit sends the webpage elements back to the client. At the client, the browser of the client displays the changed interface of the desktop application according to the received webpage elements.

According to the present invention, it is convenient to obtain data information contained in the GUI from the XML data, and thus the Web applications can be integrated. For example, it is possible to conduct a series of operations on the webpage, and output the resultant information to the other network services. Besides, it is possible to deal with the GUI to optimize or change the interactive interface.

### BRIEF DESCRIPTIONS OF THE DRAWINGS

The foregoing and other features of this invention may be more fully understood from the following description, when read together with the accompanying drawings in which:

FIG. 1 is a block diagram for showing the internal structure of the desktop application conversion system 100 according to the first embodiment of the present invention;

FIG. 1A is a block diagram for showing the internal structure of another modified example 100A of the system 100 shown in FIG. 1, which takes into account the situation that the server 20 may interact with a plurality of clients 10;

FIG. 2 is a flow chart for showing the desktop application display process of the system 100 shown in FIG. 1;

FIG. 3 is a flow chart for showing the desktop application update process of the system 100 shown in FIG. 1;

FIG. 4 is a block diagram for showing the internal structure of the desktop application conversion system 400 according to the second embodiment of the present invention;

FIG. 5 is a flow chart for showing the desktop application display process of the system 400 shown in FIG. 4;

FIG. 6 is a flow chart for showing the desktop application update process of the system 400 shown in FIG. 4;

FIG. 7 is a schematic diagram for explaining the operation process of the desktop application conversion systems according to the first and second embodiments of the present invention;

FIG. 8 is a block diagram for showing the internal structure of a prior art system; and

FIG. 9 is a flow chart for showing the operation process of the prior art system shown in FIG. 8.

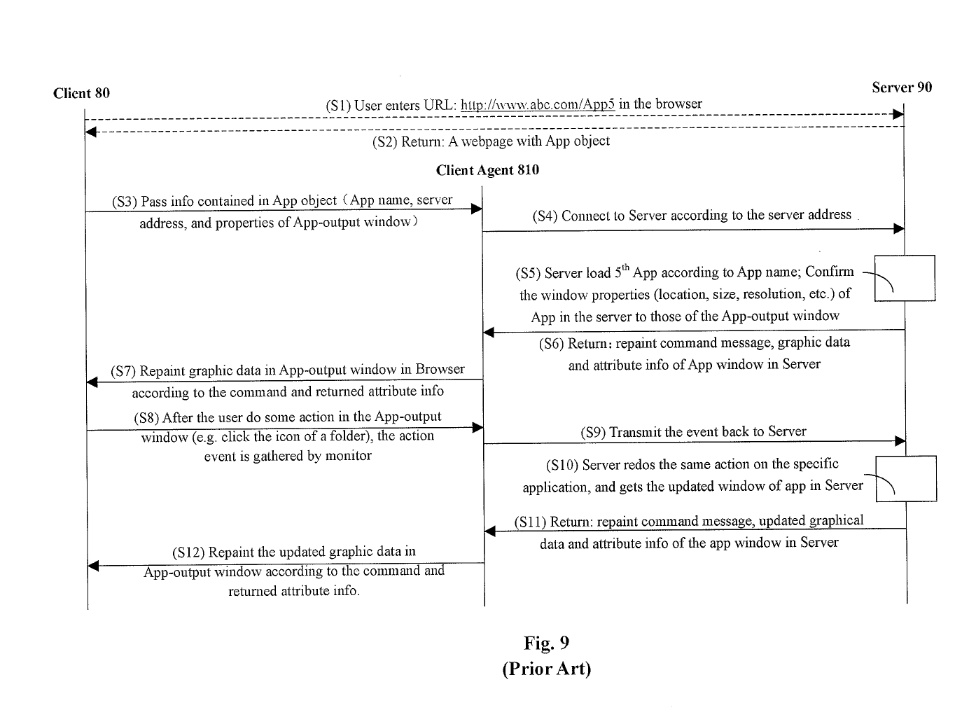

### DETAILED DESCRIPTION OF THE PREFERRED EMBODIMENTS

The methods and systems for converting a desktop application to a web application according to the present invention will be described in details below with reference to the accompanying drawings. Although the Extensible Markup Language (XML) will be described as an example to explain the principle of the invention, it can be easily understood by those skilled in the art that other well-known descriptive languages can also be applied to the present invention.

### First Embodiment

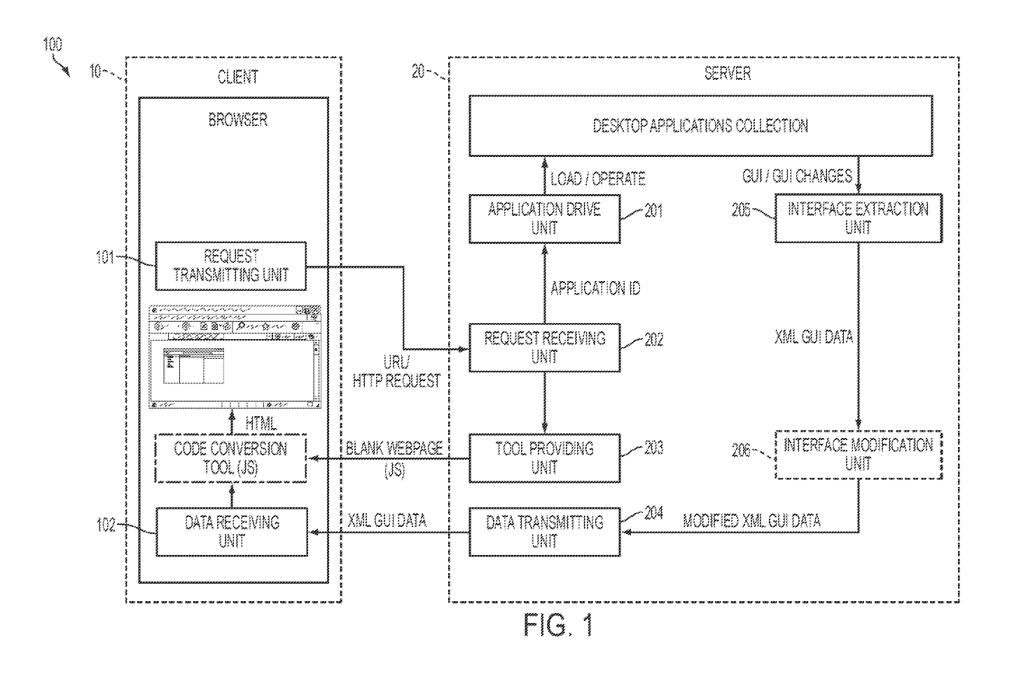

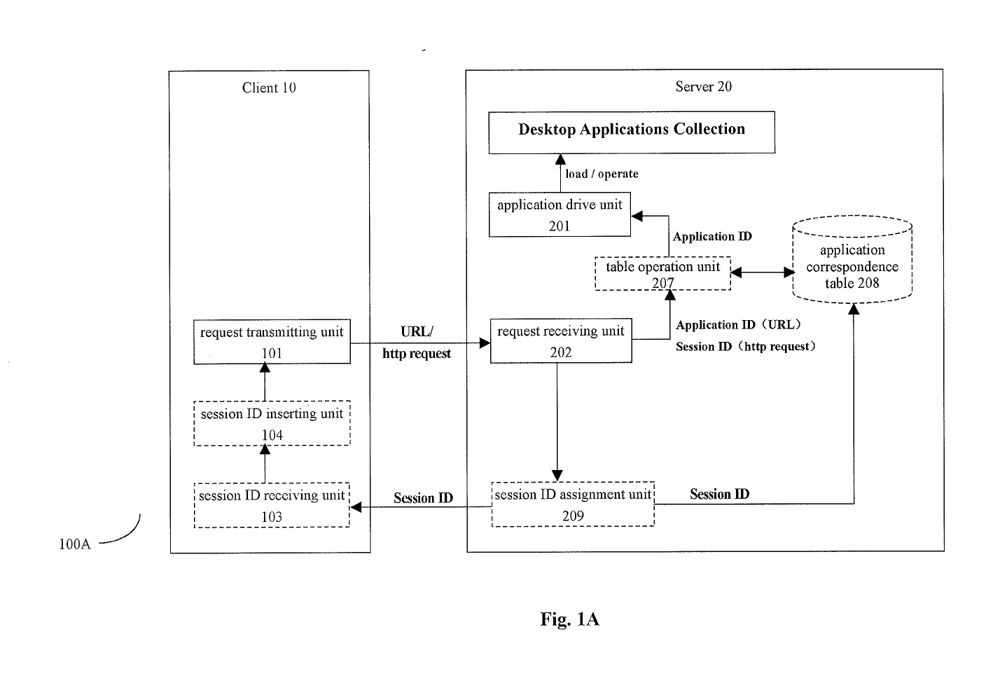

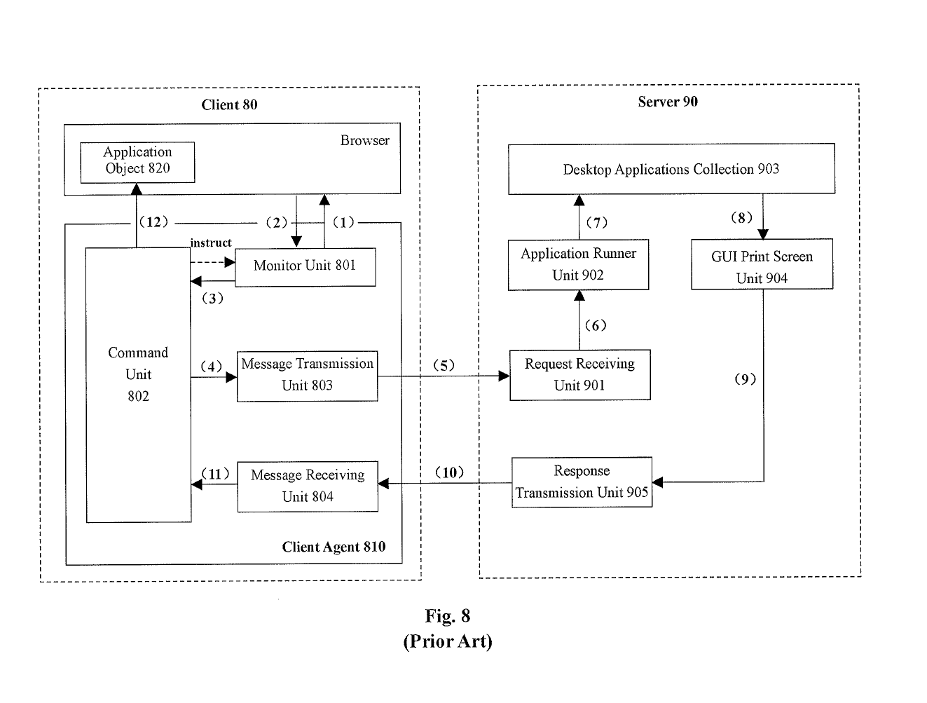

FIG. 1 is a block diagram for showing the internal structure of the desktop application conversion system 100 according to the first embodiment of the present invention. Compared with the prior art system shown in FIG. 8, it can be seen that in the desktop application conversion system 100 according to the present invention, the structure of the client has been simplified greatly. The client is on longer necessary to include a client agent in any form. As shown in FIG. 1, the client 10 may include a request transmitting unit 101 and a data receiving unit 102. The request transmitting unit 101 can transmits, for example, URL of an application the user wants to call for, or during the GUI update process, transmits a request (e.g. a http request) corresponding to an event (e.g. action) the user does on the GUI. The data receiving unit 102 is used for receiving data from the server.

In FIG. 1, the server 20 may include an application driving unit 201, a request receiving unit 202, a tool providing unit 203, a data transmitting unit 204, an interface (GUI) extraction unit 205 and an interface modification unit 206 (optional). Also, the server 20 may include the collection of the existing desktop applications.

FIG. 1A shows a modified example 100A of the system 100 of FIG. 1, in which the situation that the server 20 may interact with a plurality of clients 10 is taken into account. In order to differentiate the applications provoked by different clients, in addition of the components of the system 100 as shown in FIG. 1, the server 20 further includes a memory for storing an application correspondence table 208, a table operation unit 207 and a session ID (identifier) assignment unit 209. Correspondingly, the client 10 further includes a session ID receiving unit 103 and a session ID plug-ining unit 104. For simplicity of the explanation, only those components or portions that have information interaction with the newly added components are shown in FIG. 1A, and the other components that are the same as that in FIG. 1 are omitted.

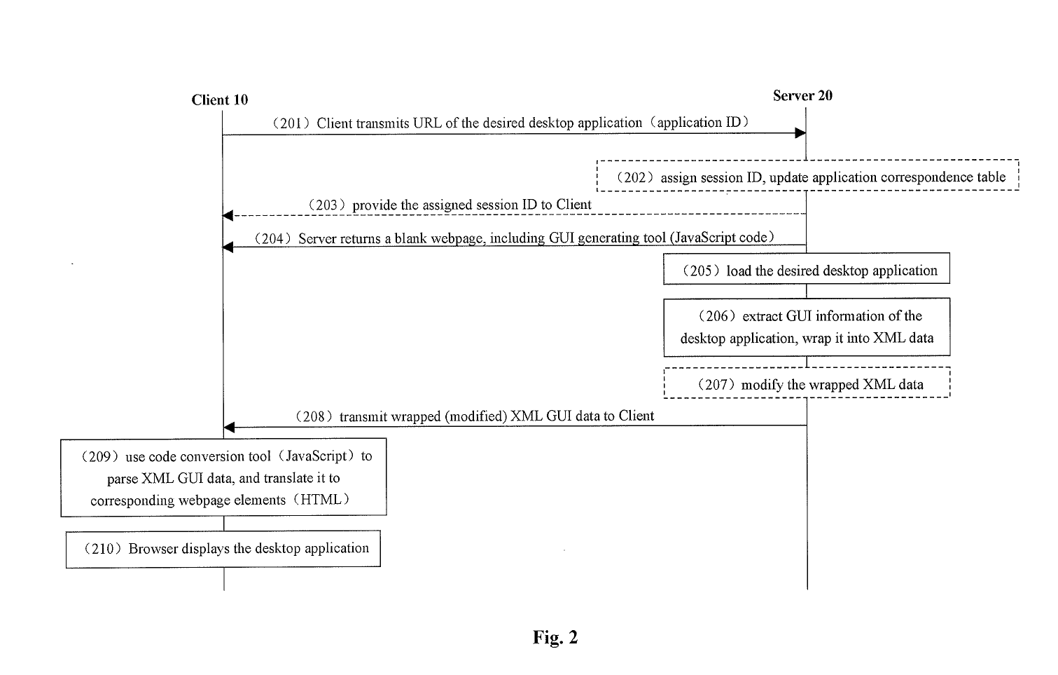

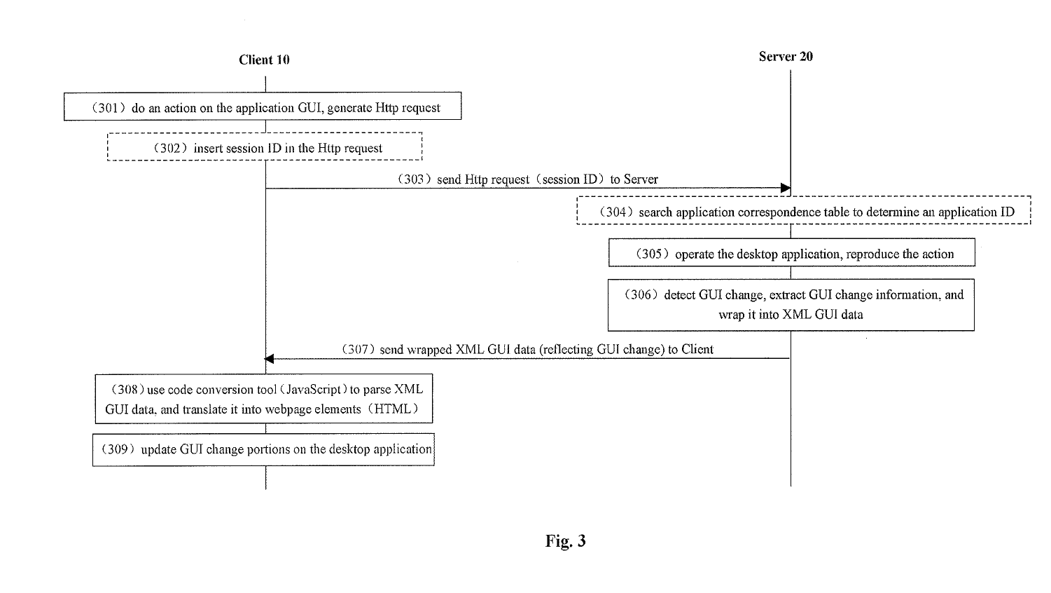

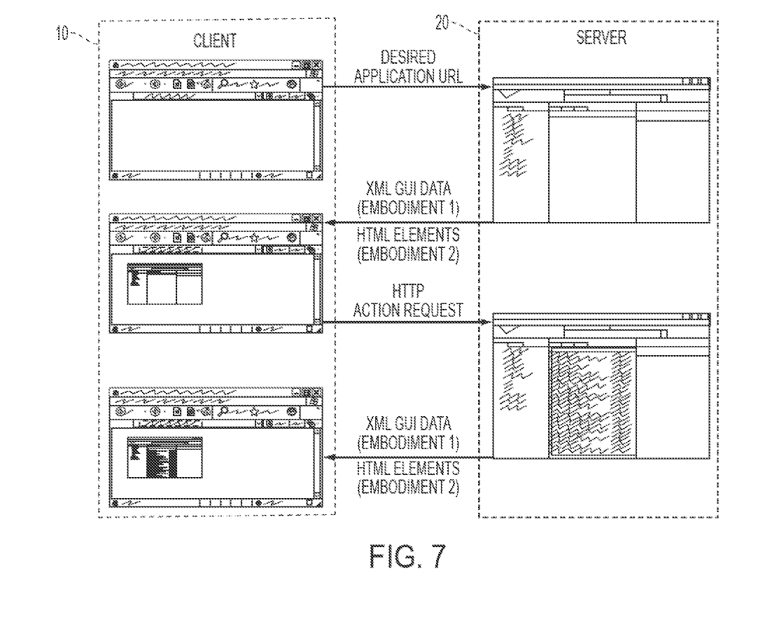

Below, the specific operation process of the desktop application conversion system 100 (100A) according to the first embodiment of the present invention will be described with reference to FIGS. 2 and 3. The example of FIG. 7 can be additionally referred to as to exhibit the operation process of the present invention.

First, the user can input URL of a desired desktop application in the address bar of the browser, e.g. URL: http://www.nec.com/App5. Then, with reference to FIG. 2, in the step 201, the client 10 transmits the URL of the desktop application the user just inputted through the request transmitting unit 101 to the server 20. In the server 20, the URL is received by the request receiving unit 202. The URL may include an application ID for identifying the desired desktop application. For example, in the example shown in FIG. 7, the user inputs URL: http://www.nec.com/App5, in which the corresponding application ID is 5. Then, in the case of FIG. 1A, to differentiate the applications provoked by different clients, the server 20 maintains an application correspondence table 208. Therefore, in the step 202, the session ID assignment unit 209 of the server 20 assigns a session ID to this specific client 10 for identifying the session established between the server 20 and this client. Then, the table operation unit 207 updates the application correspondence table 208 by adding a new entry for recording the correspondent relationship between the application ID and the session ID to the application correspondence table 208. In the step 203, the session ID that was assigned to the client 10 is sent back to the corresponding client. Upon receiving the application URL from the client, the server conducts two operations: (1) in the step 204, the tool providing unit 203 can provide a code conversion tool to the client 10. The code conversion tool can be JavaScript code or corresponding plug-in information (e.g. ActiveX, Flash, Sliverlight, Applet, etc.) contained in a blank webpage; the function and effect of the code conversion tool will be described later; and (2) in the step 205, the application driving unit 201 selects from the desktop applications collection and load the corresponding desktop application, according to the application ID that is parsed from the received URL.

After loading the corresponding desktop application (e.g. the application ID=5), in the step 206, the interface extraction unit 205 extracts GUI information of the desktop application, and wraps it to XML format data, for example. XML data can describe information of all the elements in the GUI, including unique identification, attributes (e.g. sort, size, location, content, etc.) and operation type (e.g. add, delete, update, etc.). Optionally, in the step 207, the interface modification unit 206 can modify the wrapped XML data to re-customize the GUI of the desktop application. For example, it is possible to change the layout of the GUI or add/delete functions by modifying the XML data. Then, in the step 208, the wrapped (or modified) XML data is sent back to the client through the data transmitting unit 204. In the client, the XML data is received by the data receiving unit 102 and provided to the code conversion tool which was received previously for code conversion (step 209). The code conversion tool may parse the received XML data to generate corresponding GUI elements information, thereby generating automatically the corresponding webpage (e.g. HTML data), and according to the control type on the webpage, adding JavaScript code as their response function. As described above, the code conversion tool can be JavaScript code contained in the web page or the corresponding plug-in information (e.g. ActiveX, Flash, Sliverlight, Applet, etc.). When using the plug-in information, the server can return a blank webpage containing this plug-in to the client. When the client receives the blank webpage, it is first determined whether this plug-in has been installed previously. If the client determines that the plug-in has been installed, it can be provoked directly. If the client has not installed the plug-in yet, the user can be asked whether to install the plug-in or not by using a dialogue box or the like. If the user allows, the plug-in is installed into the browser. In one embodiment, parsing of the XML data can be achieved by the DOM technique of JavaScript. For example, JavaScript can process information (including unique identification, attribute, operation type, etc.) of each GUI element in the XML GUI data one by one. If the operation type is “add”, the corresponding webpage element (e.g. HTML code for describing a button, including necessary atttributes) can be built through the interface element type (e.g. Button/TextBox/List . . . ). Then, the mapping relationship between the interface element (GUI element) and the generated webpage element can be recorded. If the operation type is “delete”, the webpage element corresponding to the GUI element is found and deleted from the webpage. Also, the corresponding mapping relationship is deleted. If the operation type is “update”, the webpage element corresponding to the GUI element is found and updated by using the received new element attribute. Besides, each GUI element can be bound to a response event. According to different types of GUI components, different events can be bound to GUI elements. For example, Button may be bound to OnClick event. If the response event is triggered, an action descriptive request is sent to the server. This request can include the unique identifier of the GUI element being operated, the action type and related parameters. Return to FIG. 2, in the step 210, the browser can use a module (e.g. rendering) contained in itself to paint and display the desired desktop application according to the webpage elements generated by the code conversion tool.

FIG. 3 is a flow chart for showing the desktop application update process. In the step 301, the user of the client does an action on the application GUI. For example, as shown in FIG. 7, the user may click on an icon of a file folder in the left tree list on the webpage. A section of JavaScript code corresponding to this HTML element can be triggered to generate a specific http request. For example, when a button on the webpage is clicked, a http request is generated: http://www.nec.com/App5/Control=button&ID=1. In the example of FIG. 1A, to indicate its identity to the server, in the step 302, the session ID inserting unit 104 of the client 10 can insert in the http request the session ID the server has provided to it in the previous communication. Then, in the step 303, the http request including the session ID is transmitted to the server and received by the request receiving unit 202 of the server. Upon receiving the http request, the table operation unit 207 extracts the session ID from the request, and determines the corresponding application ID by searching the application correspondence table 208 (step 304). In the step 305, the application driving unit 201 operates the corresponding application according to the application ID determined by the table operation unit 207, and reproduces the user's action on the GUI of the application (e.g. clicking on an icon of a file folder in the left tree list on the webpage). In this way, with reference to FIG. 7, on the server side should a list of files included in the file folder appear. Then, in the step 306, the interface extraction unit 205 detects the GUI change of the application, extracts GUI change information, and wraps it into XML format data. In the step 307, the wrapped XML data, which reflects the GUI change of the application, is transmitted back to the client through the data transmitting unit 204. In the step 308, the code conversion tool parses the received XML data and translates it into webpage elements (e.g. HTML), and the browser can dynamically update the display of the corresponding portion on the desktop application GUI (step 309).

### Second Embodiment

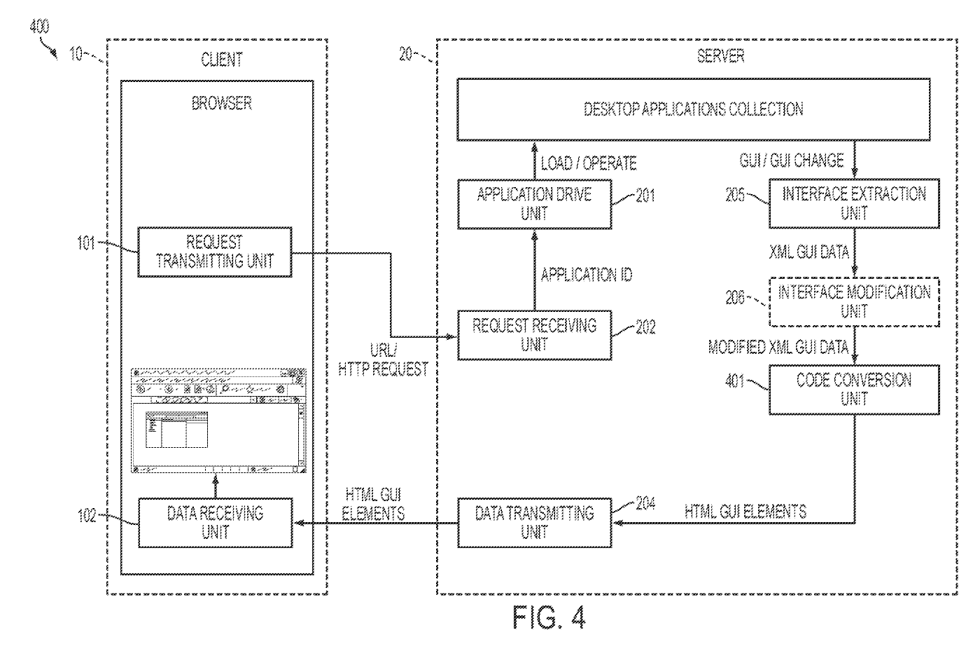

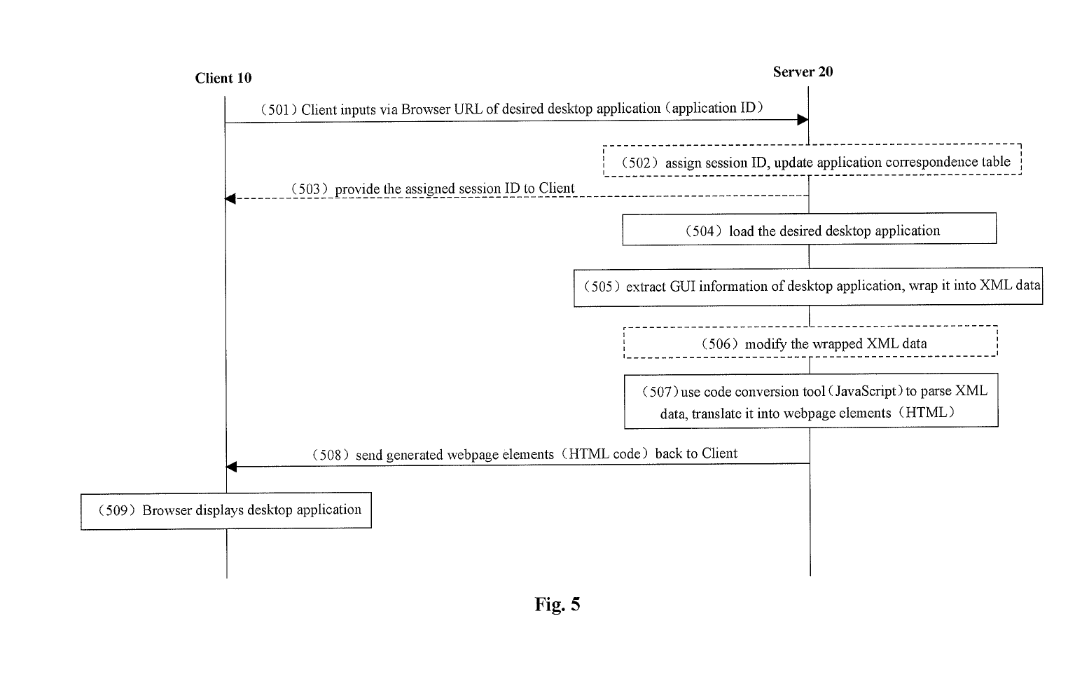

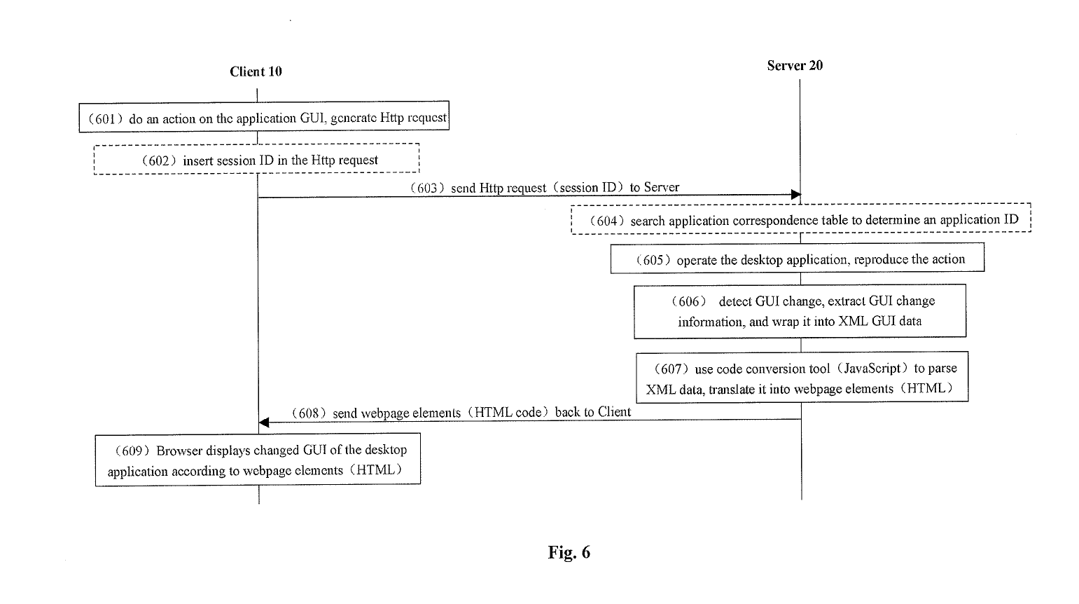

The second embodiment of the present invention will be explained with reference to FIGS. 4-7. FIG. 4 is a block diagram for showing the internal structure of the desktop application conversion system 400 according to the second embodiment of the present invention; FIG. 5 is a flow chart for showing the desktop application display process of the system 400 shown in FIG. 4; FIG. 6 is a flow chart for showing the desktop application update process of the system 400 shown in FIG. 4.

The difference between the first and second embodiments is that the code conversion function (from XML data to HTML elements) for the application GUI is no longer implemented by the client, but by the server. Therefore, compared with the system 100 shown in FIG. 1, in the system 400, the server 20 does not include the tool providing unit 203 for providing the code conversion tool. Instead, the server 20 includes in itself a code conversion unit 401. It is similar to the first embodiment that the code conversion unit 401 can be JavaScript contained in any webpage. In FIG. 4, like components as that of the first embodiment are shown in the same reference numbers and their detailed description is omitted here.

It should be noted that the second embodiment can be also applied to the situation that the server interacts with a plurality of clients. Therefore, the modified example of FIG. 1A can be applied similarly to the system 400 according to the second embodiment.

With reference to the flow charts of FIGS. 5 and 6, similarly to the first embodiment, in the step 501, the client inputs through the browser the URL of the desired desktop application. The URL may include an application ID for identifying the desktop application. In the step 502, the server assigns a session ID to the client and updates the application correspondence table 208 by adding a new entry. Then, in the step 503, the assigned session ID is sent back to the client. In the step 504, the application driving unit 201 of the server loads the desktop application. In the step 505, the interface extraction unit 205 extracts GUI information of the desktop application and wraps it into XML data. Similarly to the first embodiment, an optional step 506 is performed, in which, the interface modification unit 206 may modify the wrapped XML data to re-customize the application GUI. Here, different from the first embodiment, the wrapped (or modified) XML data is not sent back to the client, but is processed directly on the server side. In particular, in the step 507, the code conversion unit 401 uses a code conversion tool (e.g. JavaScript code) to parse the XML data, and translates it into corresponding webpage elements (e.g. HTML data). In the step 508, the data transmitting unit 204 sends the generated webpage elements (HTML data) back to the client. Then, at the client, the browser can display the desktop application directly from the received webpage elements (step 509).

With reference to FIG. 6, when the user does an action on the desktop application GUI, similarly to the first embodiment, the client generates a corresponding http request (step 601). To differentiate different clients, in the step 602, the session ID that was assigned by the server before can be inserted into the http request. Then, in the step 603, the http request is sent to the server. In the step 604, the table operation unit 207 extracts the session ID from the request, searches the application correspondence table 208 to determine the application ID corresponding to the session ID. In the step 605, the user's action can be redone on the application GUI corresponding to the application ID. In the step 606, the interface extraction unit 205 detects GUI change, extracts the whole GUI information of the changed GUI, and wraps it into XML data. Then, in the step 607, the code conversion unit 401 translates the XML data of the changed GUI into webpage elements HTML. In the step 608, the generated webpage elements are sent back to the client. Then, in the step 609, the browser can display the changed GUI of the desktop application according to the received webpage elements.

The first and second embodiments of the present invention have been described above with reference to the accompanying drawings. As mentioned above, according to the present invention, it is convenient to obtain data information contained in the GUI from the XML data, and thus the Web applications can be integrated. For example, it is possible to conduct a series of operations on the webpage, and output the resultant information to the other network services. Besides, it is possible to deal with the GUI to optimize or change the interactive interface.

However, the present invention is not limited to the particular configuration and processing shown in the accompanying drawings. In the above embodiments, several specific steps are shown and described as examples. However, the method process of the present invention is not limited to these specific steps. Those skilled in the art will appreciate that these steps can be changed, modified and complemented or the order of some steps can be changed without departing from the spirit and substantive features of the invention.

The elements of the invention may be implemented in hardware, software, firmware or a combination thereof and utilized in systems, subsystems, components or sub-components thereof. When implemented in software, the elements of the invention are programs or the code segments used to perform the necessary tasks. The program or code segments can be stored in a machine-readable medium or transmitted by a data signal embodied in a carrier wave over a transmission medium or communication link. The “machine-readable medium” may include any medium that can store or transfer information. Examples of a machine-readable medium include electronic circuit, semiconductor memory device, ROM, flash memory, erasable ROM (EROM), floppy diskette, CD-ROM, optical disk, hard disk, fiber optic medium, radio frequency (RF) link, etc. The code segments may be downloaded via computer networks such as the Internet, Intranet, etc.

Although the invention has been described above with reference to particular embodiments, the invention is not limited to the above particular embodiments and the specific configurations shown in the drawings. For example, some components shown may be combined with each other as one component, or one component may be divided into several subcomponents, or any other known component may be added. The operation processes are also not limited to those shown in the examples. Those skilled in the art will appreciate that the invention may be implemented in other particular forms without departing from the spirit and substantive features of the invention. The present embodiments are therefore to be considered in all respects as illustrative and not restrictive. The scope of the invention is indicated by the appended claims rather than by the foregoing description, and all changes that come within the meaning and range of equivalency of the claims are therefore intended to be embraced therein.

1. A method for converting a desktop application to a web application, comprising:
inputting, at a client side, URL of a desired desktop application and sending it to a server;
the server providing a code conversion tool to the client and loading the desktop application;
at the server, extracting interface information of the loaded desktop application, wrapping the interface information to data in an interface descriptive language format, and sending the wrapped data back to the client; and
at the client, parsing the received interface descriptive language data by utilizing the code conversion tool to generate relevant webpage elements, so as to display the desktop application.

2. The method according to claim 1, further comprising:
at the client, doing an action on the displayed desktop application;
sending a request corresponding to the action to the server;
at the server, redoing the action on the loaded desktop application and detecting change on the interface caused by the action, extracting interface change information corresponding to the interface change and wrapping the interface change information to data in the interface descriptive language format, and sending the wrapped data back to the client; and
at the client, parsing the received interface descriptive language data by utilizing the code conversion tool to generate relevant webpage elements, and updating a corresponding part of the displayed desktop application according to the webpage elements.

3. The method according to claim 1, further comprising:
at the server, modifying the wrapped interface descriptive language data, and sending the modified interface descriptive language data back to the client.

4. The method according to claim 1, wherein the code conversion tool is JavaScript code contained in a webpage, and the step of providing the code conversion tool comprises:
returning from the server to the client a blank webpage containing the JavaScript code.

5. The method according to claim 1, wherein the code conversion tool is a plug contained in a webpage, and the step of providing the code conversion tool comprises:
returning from the server to the client a blank webpage containing the plug;
the client determining whether it has installed the plug previously;
if the client determines that the plug has already been installed, invoking the plug directly; and
if the client determines that the plug has not been installed, inquiring the user whether it is desirable to install the plug or not, and if the user allows to install the plug, installing the plug to the browser of the client.

6. The method according to claim 2, wherein the URL of the desktop application contains an application ID for identifying the desktop application, and the server includes an application correspondence table, the method further comprises:
upon receiving the URL of the desktop application from the client, the server extracting the application ID contained in the URL and assigning a session ID to the client for identifying the session between the server and the client;
the server sending the assigned session ID back to the client;
the server updating the application correspondence table by adding an entry for recording the correspondence of the application ID and the session ID;
the client, before sending the request corresponding to the action, plug-ining the session ID into the request; and
when receiving the request, the server extracting the session ID from the request, determining the application ID corresponding to the session ID by retrieving the application correspondence table, and redoing the action on the interface of the desktop application having the retrieved application ID.

7. The method according to claim 1, wherein the interface descriptive language is Extensible Markup Language (XML).

8. The method according to claim 1, wherein the webpage elements are HyperText Markup Language (HTML) codes.

9. The method according to claim 2, wherein the request is a Hyper Text Transfer Protocol (HTTP) request.

10. A method for converting a desktop application to a web application, comprising:
inputting, at a client side, URL of a desired desktop application and sending it to a server;
the server loading the desktop application;
at the server, extracting interface information of the loaded desktop application, and wrapping the interface information to data in an interface descriptive language format;
at the server, parsing the wrapped interface descriptive language data by utilizing an code conversion tool to generate relevant webpage elements and sending the webpage elements back to the client; and
at the client, displaying the desktop application according to the received webpage elements.

11. The method according to claim 10, further comprising:
at the client, doing an action on the displayed desktop application;
sending a request corresponding to the action to the server;
at the server, redoing the action on the loaded desktop application and detecting interface change caused by the action, extracting interface information corresponding to the changed interface and wrapping the interface information to data in the interface descriptive language format;
at the server, parsing the interface descriptive language data by utilizing the code conversion tool to generate relevant webpage elements and sending the webpage elements back to the client; and
at the client, displayed the changed interface of the desktop application according to the received webpage elements.

12. The method according to claim 10, further comprising:
at the server, modifying the wrapped interface descriptive language data, and providing the modified interface descriptive language data to the code conversion tool for parsing.

13. The method according to claim 10, wherein the code conversion tool is JavaScript code contained in a webpage.

14. The method according to claim 10, wherein the interface descriptive language is Extensible Markup Language (XML).

15. The method according to claim 10, wherein the webpage elements are in HyperText Markup Language (HTML) codes.

16. The method according to claim 11, wherein the request is a Hyper Text Transfer Protocol (HTTP) request.

17. The method according to claim 11, wherein the URL of the desktop application contains an application ID for identifying the desktop application, and the server includes an application correspondence table, the method further comprises:
upon receiving the URL of the desktop application from the client, the server extracting the application ID contained in the URL and assigning a session ID to the client for identifying the session between the server and the client;
the server sending the assigned session ID back to the client;
the server updating the application correspondence table by adding an entry for recording the correspondence of the application ID and the session ID;
the client, before sending the request corresponding to the action, plug-ining the session ID into the request; and
when receiving the request, the server extracting the session ID from the request, determining the application ID corresponding to the session ID by retrieving the application correspondence table, and redoing the action on the interface of the desktop application having the retrieved application ID.

18. A system for converting a desktop application to a web application, comprising:
a client, which comprises:
a request transmitting unit for transmitting URL of a desired desktop application;
a data receiving unit for receiving data from a server; and
the server, which comprises:
a request receiving unit for receiving the URL;
a tool providing unit for providing a code conversion tool to the client;
an application drive unit for loading the desktop application;
an interface extraction unit for extracting interface information of the loaded desktop application and wrapping the interface information to data in an interface descriptive language format; and
a data transmitting unit for sending the interface descriptive language data wrapped by the interface extraction unit back to the client,
wherein at the client, the interface descriptive language data received by the data receiving unit is parsed by utilizing the code conversion tool to generate relevant webpage elements, and the browser of the client displays the desktop application according to the generated webpage elements.

19. The system according to claim 18, wherein when the user does an action on the desktop application displayed on the client, the request transmitting unit transmits a request corresponding to the action to the server, and
at the server,
the request receiving unit receives the request;
the application drive unit redoes the action corresponding to the request on the interface of the desktop application;
the interface extraction unit detects change on the interface caused by the action, extracts interface change information corresponding to the interface change and wraps the interface change information to data in the interface descriptive language format; and
the data transmitting unit sends the wrapped interface descriptive language data back to the client, and
at the client, the interface descriptive language data received by the data receiving unit is parsed by utilizing the code conversion tool to generate relevant webpage elements, and the browser of the client updates a corresponding part of the displayed desktop application according to the webpage elements.

20. The system according to claim 18, wherein the server further comprises:
an interface modification unit for modifying the interface descriptive language data wrapped by the interface extraction unit.

21. The system according to claim 19, wherein the URL of the desktop application transmitted from the client contains an application ID for identifying the desktop application, and
the server further comprises:
a memory for storing an application correspondence table;
a session ID assignment unit for assigning a session ID to the client, the session ID for identifying the session between the server and the client; and
a table operation unit,
the client further comprises:
a session ID receiving unit for receiving the session ID; and
a session ID plug-ining unit for plug-ining the session ID into subsequent requests,
wherein, when the server receives the URL of the desktop application from the client, the session ID assignment unit assigns and provides a session ID to the client, and the table operation unit updates the application correspondence table by adding an entry for recording the correspondence of the application ID and the session ID,
before the client transmits a request corresponding to an action, the session ID plug-ining unit plug-ins the session ID into the request, and
when the server receives the request, the table operation unit extracts the session ID from the request, determines the application ID corresponding to the session ID by retrieving the application correspondence table, and the application drive unit redoes the action on the interface of the desktop application having the retrieved application ID.

22. A system for converting a desktop application to a web application, comprising:
a client, which comprises:
a request transmitting unit for transmitting URL of a desired desktop application;
a data receiving unit for receiving data from a server; and
the server, which comprises:
a request receiving unit for receiving the URL;
an application drive unit for loading the desktop application;
an interface extraction unit for extracting interface information of the loaded desktop application and wrapping the interface information to data in an interface descriptive language format;
a code conversion unit for parsing the interface descriptive language data wrapped by the interface extraction unit to generate relevant webpage elements; and
a data transmitting unit for sending the webpage elements back to the client,
wherein the browser of the client displays the desktop application according to the received webpage elements.

23. The system according to claim 22, wherein when the user does an action on the desktop application displayed on the client, the request transmitting unit transmits a request corresponding to the action to the server, and
at the server,
the request receiving unit receives the request;
the application drive unit redoes the action corresponding to the request on the interface of the desktop application;
the interface extraction unit detects change on the interface caused by the action, extracts interface information corresponding to the changed interface and wraps the interface information to data in the interface descriptive language format;
the code conversion unit parses the interface descriptive language data wrapped by the interface extraction unit to generate relevant webpage elements; and
the data transmitting unit sends the webpage elements back to the client, and
at the client, the browser of the client displays the changed interface of the desktop application according to the received webpage elements.

24. The system according to claim 22, wherein the server further comprises:
an interface modification unit for modifying the interface descriptive language data wrapped by the interface extraction unit.

25. The system according to claim 23, wherein the URL of the desktop application transmitted from the client contains an application ID for identifying the desktop application, and
the server further comprises:
a memory for storing an application correspondence table;
a session ID assignment unit for assigning a session ID to the client, the session ID for identifying the session between the server and the client; and
a table operation unit,
the client further comprises:
a session ID receiving unit for receiving the session ID; and
a session ID plug-ining unit for plug-ining the session ID into subsequent requests,
wherein, when the server receives the URL of the desktop application from the client, the session ID assignment unit assigns and provides a session ID to the client, and the table operation unit updates the application correspondence table by adding an entry for recording the correspondence of the application ID and the session ID,
before the client transmits a request corresponding to an action, the session ID plug-ining unit plug-ins the session ID into the request, and
when the server receives the request, the table operation unit extracts the session ID from the request, determines the application ID corresponding to the session ID by retrieving the application correspondence table, and the application drive unit redoes the action on the interface of the desktop application having the retrieved application ID.
